(19) United States
(12) Patent Application Publication
(10) Pub. No.: US 2007/0245608 A1
(43) Pub. Date: Oct. 25, 2007

(54) LED internaly illuminated sign

(76) Inventor: William Yagoob Ahmadi, Los Angeles, CA (US)

Correspondence Address: WILLIAM AHMADI, P.O. BOX 70328, LOS ANGELES, CA, 90070, US

(21) Appl. No.: 11/410,078

(22) Filed: Apr. 25, 2006

(51) Int. Cl. G09F 13/04

(52) U.S. Cl. 40/564

(57) ABSTRACT

An internally illuminated sign having illumination provided by plurality LED Lights mounted in a light enhancing diffusion box of various designs. Included are items of construction.

### FIELD OF INVENTION

The present invention relates to a LED Illuminated Devices as used for road, highway and direction signs.

### BACKGROUND OF INVENTION

Most of the existing V Shaped Signs are used as free swing signs for highways; the existing signs have many problems including lack of visibility in low light daylight and at times when the viewer is trying to read signs facing the sun. Maintenance is very expensive and it is dangerous for maintenance personnel to access the signs on busy roadways. Existing signs are high users of electricity making demands on already overloaded grid systems. The heavy weight of existing signs place extra strain on mounting devices especially in high wind conditions.

There is therefore a need for illuminated highway or roadway signs which are more reliable with increased viewing capabilities and less expensive to operate than signs presently in use.

Light Emitting Diodes have been used in some signs as illustrated by U.S. Pat. Nos. 5,964,051 5,469,347 and 5,388,357

Solar powered signs are typified by U.S. Pat. No. 4,484,104

### BRIEF SUMMARY OF THE INVENTION

The applicant has found that the usual highway or roadway sign can be considerably improved through the use LED lights together with the use of prismatic materials in forming the message or as the background for opaque materials used for the message of such signs prismatic glass, acrylic plastic materials or other light enhancing materials may be used to enhance the visibility of the message on the sign.

When it becomes dark, such signs do require additional means to illuminate the message. A switching or light sensing device may form part of the electrical circuit responds to the level of ambient light to switch the device on and off. LEDs have proved to be highly reliable, long lasting and capable of providing the required illumination at low running cost.

A unique support system forms part of the construction of the sign and is used to fix the sign to any available support.

### DESCRIPTION OF PREFERRED EMBODIMENTS

FIG. 11 is a view of a box type sign used for elevated positions over roadways or highways. Daylight or ambient light enters the sign through the panels FIGS. 8 and 9 is transmitted to the legend panel through the Light Diffusion Plate FIG. 13. During the time of darkness or low light conditions the LED Lights in FIG. 13 are switched on by a light sensing switch, the LED Lights are illuminated by electrical power and light up the void in the inner light diffusion panel transmitting light to the Legend Plate thus causing the legend to be displayed clearly in darkness and low light conditions. At times when the sun is in a position to hinder viewer vision to see existing type signs due to glare, the present embodiments design will enhance the viewing of the legend plate and make viewing of the legend possible. In order to cause the effect and help increase the visibility of the legend, light enters the Angled Face Plate Panels 8 and 9 and is diffused through FIG. 13 thus increasing the visibility of the legend. The top, bottom and side plates are manufactured of durable, lightweight material guaranteed for long use and low maintenance. The Light Diffusion Box holding the LED Lights is removable and recyclable for low cost and easy maintenance. LED lights are estimated to last for 10,000 hours thus minimizing bulb replacements and the use of costly equipment to reach the sign. The electrical control equipment can be internal or external to the sign. The electrical power supply can be by means of mains power supply or electricity generated by photovoltaic cells and stored energy.

### BRIEF DESCRIPTION OF DRAWINGS

FIG. 1.

1.1 Plan View of Left Side Panel

1.2 Control Box

1.3 Hole for Ventilation

FIG. 2.

2.1 Side View of Left Side Panel

2.2 Control Box

FIG. 3.

3.4 Side View of Left Side Panel

FIG. 4.

3.4 Plan View of Right Side Panel

3.5 Ventilation Hole

FIG. 5.

5.6.1 Bottom Panel

FIG. 6.

6.6 End View of Bottom Panel Showing Slide Profile

FIG. 7.

7.7 Top Panel

FIG. 8.

8.7 End View of Top Panel Showing Slide Profile

FIG. 9.

9.8 Plan View of Angled Face Plate

FIG. 10.

10.8 Side View of Angled Face Plate

10.9 Internal Plate

FIG. 11.

Plan View showing sign construction

12.2 Control Box

12.14 Retaining Nuts

12.15 Assembly Bolts

FIG. 12

Side View of Sign showing construction

12.8 Outer Angled Panel

12.9 Inner Angle Panel

FIG. 13.

13.10 LED Lights

13.11 Side View of Light Diffusion Box

13.12 Side view of Light Diffusion Box Top Plate

FIG. 14.

Alternative Light Diffusion Box

14.10 LED Lights

14.13 Alternative Diffusion Profile

FIG. 15.

Side View of FIG. 14 Diffusion Box

FIG. 16.

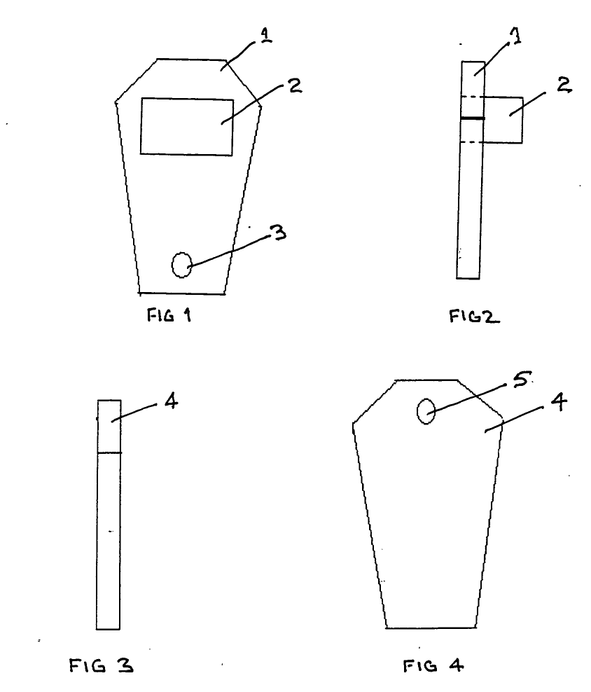

Alternative Light Diffusion Profile

16.11 Diffusion Box Frame

16.12 Diffusion Box Top Plate

16.13 Alternative Diffusion Profile

I claim:

1. A sign, comprising of a frame with a Top Panel, a Bottom Panel, two side panels and a front and back panel, the front and back panels or only one panel may hold a legend for a sign, the front and back panels are of light enhancing material, allowing light to enter, light can also enter the sign from light enhancing panels inserted into the two side panels, the Top and Bottom Panels are shaped to allow the Front and Back Panels to slide into them to form a V Shaped Sign.

2. A sign, comprising of: a frame with a top Panel, a Bottom Panel, two side panels and a front and back panel, both front and back panels or only one panel may hold a legend for a sign, the front and back panels are of light enhancing material, adjacent to the front and back light enhancing panels, a light diffusion box containing LED lights and a light enhancing diffusion system, the Top and Bottom Panels are shaped to allow the Front and Back Panels to slide into them to form a V Shaped Sign.

3. A sign as in claim 2 including alternative LED placement as described in FIG. 14.

4. (canceled)

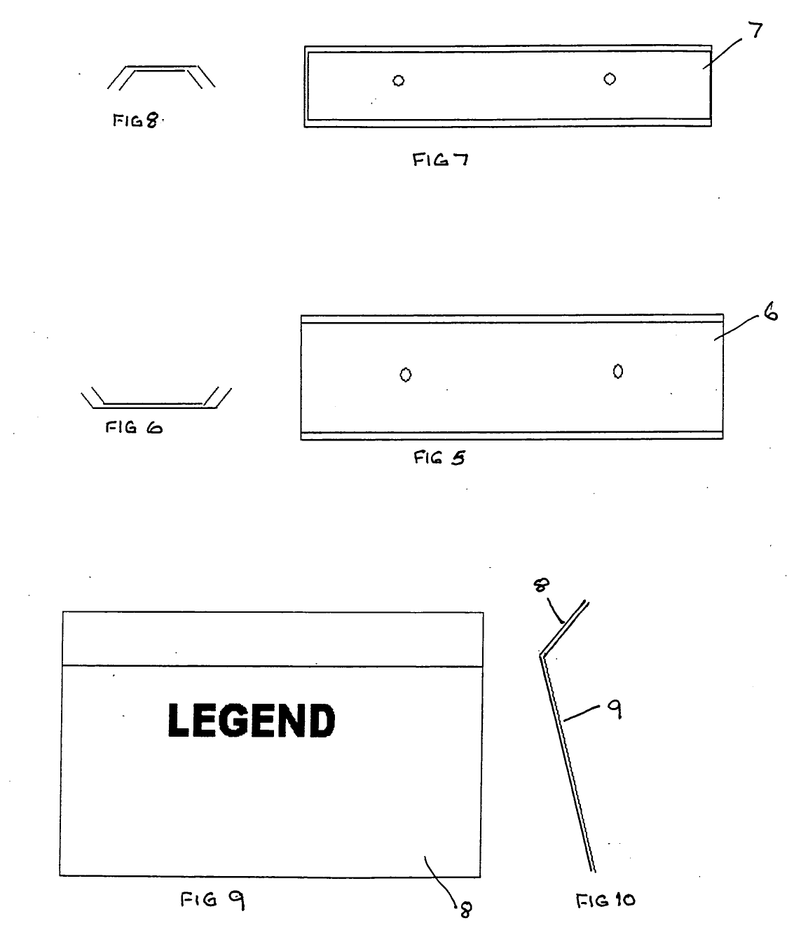

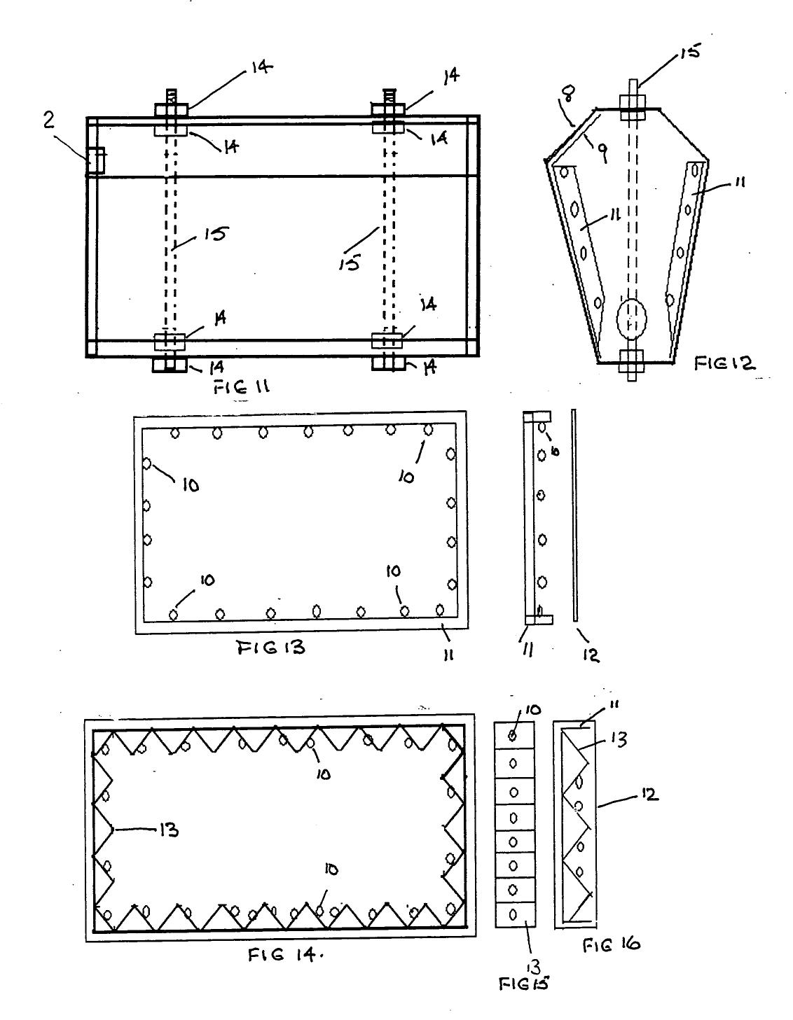

5. A Fabricated, molded or extruded Bottom Panel as described in FIGS. 5 and 6.

6. A sign as described in claim 1 including Top Panel a described in claim 5.

7. A sign as described in claim 1 including Bottom Panel a described in claim 5.

8. A sign as described in claim 1 using a Front and Back Panel as described in FIGS. 9 and 10.
